(19) United States
(12) Patent Application Publication
(10) Pub. No.: US 2026/0352654 A1
(43) Pub. Date: Nov. 5, 2026

(54) METHOD AND SYSTEM FOR ESTABLISHING SECURITY CONTEXT IN A DISTRIBUTED NON-ACCESS STRATUM (NAS)

(71) Applicant: SAMSUNG ELECTRONICS CO., LTD., Suwon-si (KR)

(72) Inventors: Jagadeesh GANDIKOTA, Bangalore (IN); Neha SHARMA, Bangalore (IN); Arvind RAMAMURTHY, Bangalore (IN); Arijit SEN, Bangalore (IN); Ankur POONIYA, Bangalore (IN)

(21) Appl. No.: 19/718,615

(22) Filed: Jun. 24, 2026

Related U.S. Application Data
(63) Continuation of application No. PCT/KR2026/007006, filed on Jun. 16, 2026.

(30) Foreign Application Priority Data
May 26, 2006 (IN) 202511057856
Jun. 16, 2026 (IN) 202511057856

(51) Int. Cl. H04L 9/40

(52) U.S. Cl. CPC H04L 63/083

(57) ABSTRACT

A disclosed method includes: receiving encoded service message associated with NAS procedure intended for establishing NF specific security context for secondary NF node, from one of, UE or primary NF node; determining whether security context is already established between UE and secondary NF node, based on one of, information included in encoded service message or query to SF node storing primary security context; based on the determination, causing establishment of security context by performing one of retrieving, from SF node, one of, primary security context or shared security context, previously established between UE and primary NF node, when the UE previously initiated primary authentication and key agreement procedure with primary NF node. Else initiating, with UE, one of, secondary authentication and key agreement procedure, or SMC procedure to derive the NF specific security context.

### CROSS-REFERENCE TO RELATED APPLICATIONS

This application is a continuation of International Application No. PCT/KR 2026/007006 designating the United States, filed on Jun. 16, 2026, in the Korean Ministry of Intellectual Property Receiving Office and claiming priority to Indian Provisional Patent Application No. 202511057856, filed on Jun. 16, 2025, and Indian Non-Provisional Patent Application No. 202511057856, filed on May 26, 2026, in the Indian Patent Office, the disclosures of each of which are incorporated by reference herein in their entireties.

### BACKGROUND

### Field

The disclosure relates to the field of communication networks and security establishment in a distributed Non-Access Stratum (NAS). For example, but not exclusively, the disclosure relates to a method and a secondary Network Function (NF) node for establishing security context in the distributed Non-Access Stratum (NAS).

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve spectrum efficiency of wireless interfaces and reduce the signaling overhead.

In cellular communication systems such as LTE and 5G, Non-Access Stratum (NAS) signalling is used to support control-plane communication between a user equipment (UE) and the core network. NAS signalling enables procedures such as authentication, security establishment, mobility management, and session control, and is logically separate from radio access signalling. In current systems, NAS signalling is transported transparently by the radio access network and is terminated at a centralized core network function, such as a Mobility Management Entity in LTE or an Access and Mobility Management Function in 5G. During an initial authentication procedure, a NAS security context is established between the UE and the centralized network function, and subsequent NAS messages are protected using that established security context.

Under this centralized NAS security architecture, NAS messages related to procedures handled by other core network functions are routed through the centralized function, which performs integrity verification and decryption before forwarding relevant information to the appropriate secondary network functions. Secondary network functions therefore do not directly establish NAS security associations with the UE and depend on the centralized network function to authenticate the UE and validate NAS signalling. This approach simplifies control-plane security by confining NAS security termination to a single point in the core network. However, the centralized NAS security model has limitations in modern communication networks. Concentrating NAS security handling at a single network function can introduce scalability constraints and create a reliance on that function for all NAS-level trust decisions. Secondary network functions are unable to apply independent NAS-level security policies or directly verify NAS messages originating from the UE. In addition, routing NAS messages through a centralized function for security processing may increase signalling overhead and latency, particularly when NAS procedures are primarily relevant to other network functions.

Furthermore, existing NAS security mechanisms provide limited support for handling changes in network-function deployment, such as when network function instances are relocated, replaced, or scaled due to user mobility or network reconfiguration. Maintaining security continuity across such changes can require additional signalling or re-establishment procedures. As core networks evolve toward more distributed and virtualized architectures, these characteristics of centralized NAS security highlight challenges in accommodating flexible deployment models and dynamic network behavior within existing NAS signalling frameworks.

The information disclosed in this background of the disclosure section is only for enhancement of understanding of the general background of the disclosure and should not be taken as an acknowledgement or any form of suggestion that this information forms prior art already known to a person skilled in the art.

### SUMMARY

According to an example embodiment of the disclosure, a method of establishing security context in a distributed Non-Access Stratum (NAS) is disclosed. The method comprises: receiving an encoded service message associated with a Non-Access Stratum (NAS) procedure intended for establishing an NF specific security context for the secondary NF node, from one of, a User Equipment (UE) or a primary NF node; determining whether a security context is already established between the UE and the secondary NF node, based on one of, information included in the encoded service message or a query to a Security Function (SF) node storing a primary security context; based on the determination, causing establishment of the security context by performing one of retrieving, from the SF node, one of, the primary security context or a shared security context, previously established between the UE and the primary NF node, wherein the UE previously initiated a primary authentication and key agreement procedure with the primary NF node; and based on determining there was no security context already established between the UE and the secondary NF node, initiating, with the UE, one of, a NAS message such as secondary authentication and key agreement procedure, or a Security Mode Command (SMC) procedure to derive the NF specific security context.

According to an example embodiment of the disclosure, a secondary Network Function (NF) node for establishing security context in a distributed Non-Access Stratum (NAS) is disclosed. The secondary NF node comprises: at least one processor, comprising processing circuitry, and a memory communicatively coupled to at least one processor, where the memory stores processor executable instructions, which, on execution by at least one processor, individually or in any combination, may cause the secondary NF node to: receive an encoded service message associated with a Non-Access Stratum (NAS) procedure intended for establishing an NF specific security context for the secondary NF node, from one of, a User Equipment (UE) or a primary NF node; determine whether a security context is already established between the UE and the secondary NF node, based on one of, information included in the encoded service message or a query to a Security Function (SF) node storing a primary security context; based on the determination, cause establishment of the security context by performing one of retrieving, from the SF node, one of, the primary security context or a shared security context, previously established between the UE and the primary NF node, wherein the UE previously initiated a primary authentication and key agreement procedure with the primary NF node; and based on determining there was no security context already established between the UE and the secondary NF node, initiating, with the UE, one of, a secondary authentication and key agreement procedure, or a Security Mode Command (SMC) procedure to derive the NF specific security context.

According to an example embodiment of the disclosure, a method of establishing security context in a distributed Non-Access Stratum (NAS) is disclosed. The method comprises: maintaining a plurality of security contexts associated with a plurality of Network Functions (NFs) comprising a primary NF node and a plurality of secondary NF nodes; establishing a primary security context with a primary Network Function (NF) node by initiating a primary authentication and key agreement procedure with the primary NF node; and transmitting an encoded service message associated with a Non-Access Stratum (NAS) procedure intended for establishing one of, a shared security context, or an NF specific security context for a secondary NF node, to one of, the secondary NF node or the primary NF node.

According to an example embodiment of the disclosure, a UE for establishing security context in a distributed Non-Access Stratum (NAS) is disclosed. The UE comprises: at least one processor, comprising processing circuitry, and a memory communicatively coupled to the processor, where the memory stores processor executable instructions, which, on execution by at least one processor, individually or in any combination, may cause the UE to: maintain a plurality of security contexts associated with a plurality of Network Functions (NFs) comprising a primary NF node and a plurality of secondary NF nodes; establish a primary security context with a primary Network Function (NF) node by initiating a primary authentication and key agreement procedure with the primary NF node; and transmit an encoded service message associated with a Non-Access Stratum (NAS) procedure intended for establishing one of, a shared security context, or a NF specific security context for a secondary NF node, to one of, the secondary NF node or the primary NF node.

The foregoing summary is illustrative and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and include a part of this disclosure, illustrate various example embodiments and, together with the description, serve to explain the disclosed principles. The same numbers are used throughout the figures to reference like features and components.

The above and other aspects, features and advantages of certain embodiments of the present disclosure will be more apparent from the following detailed description, taken in conjunction with the accompanying drawings, in which:

FIG. 1 is a diagram illustrating an example environment for establishing security context in a distributed Non-Access Stratum (NAS), according to various example embodiments;

FIG. 2 is a signal flow diagram illustrating an existing centralized Non-Access Stratum (NAS) communication approach;

FIGS. 3A, 3B, 3C, 3D, 3E, 3F and 3G are signal flow diagrams illustrating various example operations for establishing security contexts in 6G Network Functions (NFs), according to various example embodiments;

FIG. 4 is a block diagram illustrating an example configuration of a secondary Network Function (NF) node, according to various example embodiments;

FIG. 5 is a block diagram illustrating an example configuration of a User Equipment (UE), according to various example embodiments;

FIG. 6 is a flowchart illustrating an example method for establishing security context in a distributed Non-Access Stratum (NAS) at a secondary Network Function (NF) node, according to various example embodiments;

FIG. 7 is a flowchart illustrating an example method for establishing security context in a distributed Non-Access Stratum (NAS), at a User Equipment (UE), according to various example embodiments; and

FIG. 8 is a block diagram illustrating an example configuration of a system according to various example embodiments.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present disclosure, the word “exemplary” is used herein may refer to “serving as an example, instance, or illustration.” Any embodiment or implementation of the present subject matter described herein as “exemplary” is not necessarily to be construed as preferred or advantageous over various other embodiments.

While the disclosure is susceptible to various modifications and alternative forms, various example embodiments are illustrated and described by way of example in the drawings and will be described in greater detail below. It should be understood, however, that it is not intended to limit the disclosure to the forms disclosed, but on the contrary, the disclosure is intended to cover all modifications, equivalents, and alternative falling within the scope of the disclosure.

The terms “comprises,” “comprising,” “includes” or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to the field of communication. For example, the present disclosure pertains to systems and methods for establishing and maintaining security context in distributed non-access stratum (NAS) architecture.

The present disclosure addresses one or more shortcomings of the prior art and provides additional advantages discussed throughout the present disclosure. Additional features and advantages may be realized through the techniques of the present disclosure. Various example embodiments and aspects of the disclosure are described in detail herein and are considered a part of the claimed disclosure.

Handling of subscription, authentication, and security aspects in a distributed NAS system is disclosed, in accordance with various embodiments of the present disclosure.

In the current art, the user equipment (UE) registers with the Access and Mobility Management Function (AMF), and the registration context of the UE is with the AMF and the Unified Data Management (UDM) function. This is shown in first step (Registration) and second step (Update).

In a distributed architecture, where the UE can have a peer-to-peer (P2P) link with the network functions, it is important that all network functions have context of the UE before the UE connects with them. In order to achieve that, the AMF, at the time of UE registration, may broadcast the UE context on the Service-Based Architecture (SBA) for other network functions to absorb. Alternatively, network functions on the Service-Based Interface (SBI) can query the UDM or the Unified Data Repository (UDR) and obtain the subscription data of the UE. This process is shown in step S3 (P2P connection request-SUCI) and step S4 (Nudm_SDM_Get). In an embodiment, network functions on the Service-Based Interface (SBI) can query the UDM or the Unified Data Repository (UDR) and obtain the subscription data of the UE.

Network functions may also query the Authentication Server Function (AUSF) to obtain the authentication and authorization status of the UE, and the NAS security keys if already present. This is referred to as a Common Security context. A network function, with the help of the AUSF, may choose to perform its own authentication and security procedure and deliver the keys to the UE. This is referred to as an Independent Security context. Tease actions are shown in fifth step (Authentication and Security) and sixth step (New Key Delivery). With subscription and security context established, each network function can independently and securely communicate with the UE over a P2P interface.

A primary authentication and key agreement procedure between the user equipment (UE) and the Access and Mobility Management Function (AMF) in a 5G system, in accordance with prior art is described.

At a first step, the Authentication Vector (AV) is generated at the Unified Data Management (UDM) or Authentication credential Repository and Processing Function (ARPF). At a second step, the AV is sent from the UDM to the Authentication Server Function (AUSF) as part of the Nudm_UEAuthentication_Get Response.

At a third step, the AUSF forwards the authentication information to the Security Anchor Function (SEAF) using a Nausf_UEAuthentication_Authentication Response. At a fourth step, the SEAF sends an authentication request (Auth-Req) to the UE, which includes the EAP Request or AKA′-Challenge, ngKSI, and ABBA.

At a fifth step, the UE calculates the authentication response based on the received challenge. At sixth step, the UE sends back the authentication response (Auth-Resp) to the SEAF, containing the EAP Response or AKA-Challenge. At a seventh step, the SEAF forwards the UE's response to the AUSF in a Nausf_UEAuthentication_Authenticate Request.

At an eighth step, the AUSF verifies the response received from the UE. A ninth step may involve an optional exchange of further EAP messages between the UE and the AUSF. At a tenth step, the AUSF sends a Nausf_UEAuthentication_Authenticate Response to the SEAF, which includes either EAP Success or the Anchor Key, along with the SUPI. Finally, at an eleventh step, the SEAF sends an NAS Message to the UE containing EAP Success, ngKSI, and ABBA.

An individual NAS security context, maintained by the UE for different network functions is described, in accordance with various example embodiments of the present disclosure.

At a first step, initial registration and authentication take place between the user equipment (UE) and the Access and Mobility Management Function (AMF). At a second step, the UE encodes and sends an NAS message (e.g., UL NAS TRANSPORT or PDU Session Establishment Request) to the Radio Access Network (RAN). At a third step, the RAN forwards the NAS message transparently to the AMF.

At a fourth step, the AMF decodes the message and sends the Session Management (SM) message, e.g., PDU Session Establishment Request, to the Session Management Function (SMF). At a fifth step, the AMF sends an Nsmf_PDU_Session_CreateSMContext request to the SMF. At sixth step, the PDU session authentication and establishment procedure is completed between the UE and the SMF, using the security context that was established between the UE and the AMF.

A shared security context architecture is disclosed where each network function (NF) maintains its own independent security context with the UE, in accordance with various example embodiments of the present disclosure.

At a first step, initial registration and authentication occur between the UE and the AMF. At a second step, the UE encodes and sends an NAS message (e.g., UL NAS TRANSPORT or PDU Session Establishment Request) to the RAN. At a third step, the RAN forwards the NAS message transparently to the SMF. At a fourth step, if the SMF is contacted for the first time and does not have an existing UE security context, it initiates the primary authentication and key agreement procedure. This occurs at the SMF.

At a fifth step, the primary authentication and key agreement procedure is executed between the UE and the SMF. At a sixth step, the UE stores a separate security context for each network function and uses the corresponding context while interacting with that network function. At a seventh step, the SMF stores the UE's security context and uses it for subsequent communications with the UE. At an eighth step, the PDU session establishment procedure is completed between the UE and the SMF using the newly established security context.

A shared security context architecture for 6^{th} generation network functions is disclosed, in accordance with various example embodiments of the present disclosure.

Since the user equipment (UE) can interact with any network function directly in 6GS without going through a transparent network function, a key question arises does the UE need to maintain an independent security context for each network function, or can a common security context be utilized across network functions. The security context includes parameters such as but not limited to integrity and ciphering keys, the Key Set Identifier (KSI), and uplink (UL) and downlink (DL) NAS count values.

When the UE initially registers with the first network function, for example the Access and Mobility Management Function (AMF), the AMF performs the primary authentication and key agreement procedure and derives the UE security context. This context is then stored for later use by other network functions authorized to access it. In the illustrated example, a Security Function (SF) is introduced to store and provide access to the UE's security context. The SF may be a standalone function or part of an existing function such as the AMF or Authentication Server Function (AUSF).

The procedure, may begin with a first step, where the UE sends a registration request to the AMF. At a second step, authentication and security establishment are performed between the UE and the AMF. At a third step, the UE security context is stored inside the Security Function (SF), accessible by other network functions. At a fourth step, the UE encodes and sends an NAS message (e.g., UL NAS TRANSPORT or PDU Session Establishment Request) to the Radio Access Network (RAN).

At a fifth step, the RAN forwards the NAS message transparently to the Session Management Function (SMF). At a sixth step, the SMF fetches the UE security context from the Security Function (SF). At a seventh step, the SMF decodes the NAS message using the fetched security context. At an eighth step, the SMF sends an encoded NAS message (e.g., PDU Session Establishment Accept) to the UE.

In an example embodiment, as an implementation option, instead of sharing the same security context, a random value may be generated for each NF and the random value may be stored in the security function or any other existing function such as UDM or AUSF. The random value may be shared with UE during primary authentication and key agreement procedure from individual NF or in the DL NAS message separately after the first registration is successful which then may be used to derive the new security context for each NF at UE and NW side.

Whenever the primary security context is updated, all the further derived security contexts will be re calculated.

Further, storing of security contexts at the user equipment (UE) is disclosed, in accordance with various example embodiments of the present disclosure.

In an embodiment of the independent security context, the UE may send an NAS message to RAN and RAN may forward the NAS message to the network function (NF) (for example SMF/UPF). The NF upon identifying that this network function doesn't have the UE security context, the NF may initiate the primary authentication and key agreement procedure with the UE and derive the security context on successful authentication procedure. Both UE and NF may store this security context independently per NF and use the security context for further communications.

In an embodiment of the shared security context a common security context across the NFs may be disclosed. The common security context may be established at the time of first registration (example with AMF) and then the common security context will be shared by all the network functions that access the network function. security context includes but not limited to the integrity and ciphering key, KSI and UL and DL NSA counts etc.

In an embodiment, a broadcasted security context is disclosed. In the broadcasted security context, the network function establishing the security context with the UE can also broadcast the security context on the SBA to other network functions that the UE may directly communicate with in the future.

In the current art, the UE maintains a single NAS security context, which includes the ciphering key (Ck), integrity key (Ik), Key Set Identifier (KSI), and uplink/downlink NAS count values. Further, 11b illustrates an approach where the UE maintains individual NAS security contexts for each network function (NF) it interacts with. For example, separate security contexts are maintained for the Access and Mobility Management Function (AMF), Session Management Function (SMF), and Policy Control Function (PCF), with each context containing its own set of Ck, Ik, KSI, and UL/DL NAS count values.

An alternative model involves using a shared NAS security context across multiple network functions. In this model, a single security context—including Ck, Ik, KSI, and UL/DL NAS count—is reused by all authorized NFs, such as AMF, SMF, and PCF.

Key handling during inter system change between the sixth generation and the fifth generation or fourth generation networks is disclosed, in accordance with various example embodiments.

At a first step, initial registration and authentication occur between the user equipment (UE) and the Access and Mobility Management Function (AMF). At a second step, the UE encodes and sends an NAS message (for example, UL NAS TRANSPORT or PDU Session Establishment Request) to the Radio Access Network (RAN). At a third step, the RAN forwards the NAS message transparently to a Session Management Function (SMF1).

At a fourth step, if the UE is being contacted for the first time, SMF1 initiates the primary authentication and key agreement procedure. At a fifth step, the primary authentication and key agreement procedure is performed between the UE and SMF1. At a sixth step, the UE stores a separate security context for each network function and uses the respective context while interacting with that function. At a seventh step, SMF1 stores the UE's security context and uses it for further communication with the UE.

At an eighth step, the PDU session establishment procedure is completed using the newly derived security context between the UE and SMF1. At a ninth step, the UE sends a mobility registration or Tracking Area Update (TAU) message to a 5GS or 4GS system and uses the mapped Mobility Management (MM) security context derived during the initial registration with the AMF. At a tenth step, when transitioning back from 6G to 5G, the UE uses the MM security context mapped from the 4G MM security context, and for all other network functions, new and independent security contexts are derived. At an eleventh step, the mobility registration procedure is completed using the mapped security context.

A method to fetch the user equipment (UE) security context from an old network function (NF) is disclosed, in accordance with various example embodiments of the present disclosure.

At a first step, Initial Registration and Authentication is performed between the UE and the network. At a second step, the UE encodes and sends an NAS Message (for example, UL NAS TRANSPORT/PDU Session establishment Request). At a third step, the RAN forwards the NAS Message (for example, UL NAS TRANSPORT PDU Session establishment Request) transparently to SMF2. At a fourth step, upon determining that it does not have the UE security context, SMF2 sends a Security Context Fetch request to SMF1. At a fifth step, SMF1 sends the UE Security Context to SMF2. At a sixth step, UE and SMF2 complete PDU session establishment using the fetched security context. Thus, the method enables seamless transition and secure communication between the UE and multiple network functions in a distributed NAS architecture by reusing existing security context.

The signaling mechanism is disclosed which is used to indicate whether a shared or independent security context is to be applied for different network functions (NFs) in a 6G network, in accordance with various example embodiments of the present disclosure.

In various example embodiments, the network may use a combination of both shared security context and independent security context establishment methods. The network (NW) may notify the user equipment (UE) about the applicable security context model for different NFs during the registration phase or through other Non-Access Stratum (NAS) signaling messages.

In an embodiment, the network may notify the UE of the NFs that use a common security context mechanism via a Registration Accept or other NAS signaling message. For example, during mobility, the network may indicate a change in the security policy depending on the deployment context.

If the network supports shared security context only for a limited set of NFs (e.g., the Session Management Function (SMF)), it may notify the UE through Registration Accept or Configuration Update Command messages that shared security context is supported only for SMF. For all other NFs, the UE will be required to perform independent security context establishment.

If the UE enters a new area where the network supports a shared (common) security context for all NFs, the network may notify the UE via a NAS control message (e.g., Configuration Update Command) that the common security context is supported across all network functions. In such a case, the UE uses a single common set of security keys for communication with all NFs. The order in which the method is described is not intended to be construed as a limitation, and any number of the described method blocks can be combined in any order to implement the method. Individual operations may be deleted from the methods without departing from the scope of the subject matter described herein. The method can be implemented in any suitable hardware, software, firmware, or combination thereof.

Disclosed herein is a method and system for establishing and managing security contexts in a distributed Non-Access Stratum (NAS) communication network. In existing cellular communication systems, NAS signalling and associated security procedures are centralized at a primary Network Function (NF) node. The primary NF node may correspond to NFs such as an access and mobility management function, with which a User Equipment (UE) establishes a single security context during authentication. Secondary NFs rely on the primary NFs for NAS security termination and message validation, and do not directly maintain security associations with the UE. This centralized approach limits flexibility in applying security policies which are NF-specific and introduces additional signalling overhead due to routing of NAS messages through a central entity. The existing approach also provides limited mechanisms to efficiently maintain security continuity when NF instances change due to mobility, scaling, or network reconfiguration.

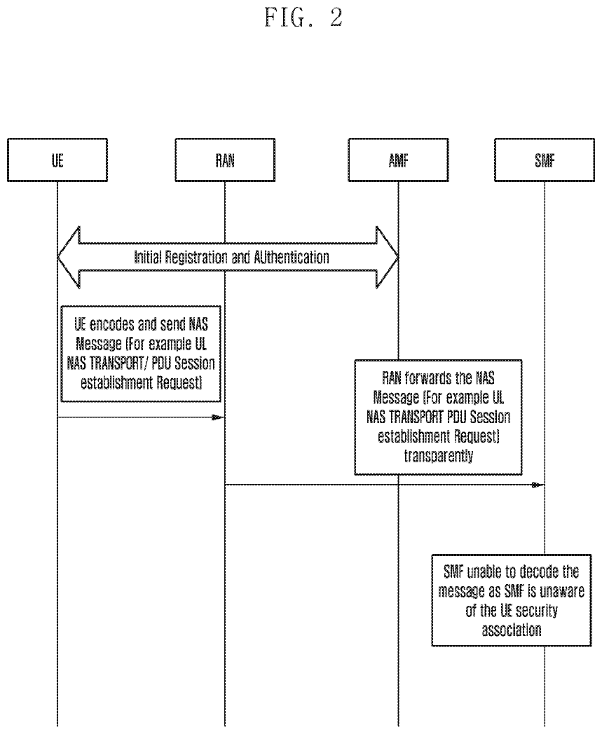

FIG. 2 is a signal flow diagram illustrating operations of an existing centralized Non-Access Stratum (NAS) communication approach. Distributed Non-Access Stratum (NAS) may refer to a communication architecture in which NAS signalling processing, security handling, and control-plane decision-making are not confined to a single centralized network function but are instead distributed across multiple network functions within the core network. In such an approach, a User Equipment (UE) is enabled to establish secure and authenticated NAS communication directly with different network functions (e.g., mobility management, session management, policy control functions), rather than relying on a single anchor entity to terminate and relay all NAS messages. This is achieved through mechanisms such as shared or independently derived security contexts, function-specific key derivation, or explicit signalling frameworks, thereby allowing each network function to autonomously decode, verify, and process NAS messages. Distributed NAS architecture improves scalability, reduces signalling latency, supports flexible service interactions, and facilitates a zero-trust security model by eliminating strict dependency on centralized NAS termination and enabling localized control-plane intelligence across the network.

FIG. 2 illustrates an existing centralized NAS communication approach in which security and NAS control plane processing are anchored at a single core network function, specifically the Access and Mobility Management Function (AMF). As shown in the call flow, when a User Equipment (UE) initially registers with the network, the UE performs registration and authentication procedures with the AMF via the Radio Access Network (RAN). During this process, the AMF executes the primary authentication and key agreement procedures and derives a UE security context, including NAS security keys. This UE security context is maintained and stored exclusively at the AMF. Subsequent NAS messages generated by the UE, such as a session management message (e.g., a PDU session establishment request), are NAS-encoded and transmitted by the UE to the RAN, which then forwards the NAS message transparently toward the target core network function.

The call flow further demonstrates that when such the NAS message is routed directly to another core network function, such as a Session Management Function (SMF), without being terminated and processed by the AMF, the receiving network function lacks access to the UE security context. As a result, the SMF is unable to independently validate the authenticity or integrity of the received NAS message because the corresponding NAS security association and keys are not available to it. This highlights a fundamental limitation of the centralized NAS architecture depicted in the figure, namely that NAS security context visibility and processing are confined to the AMF, rendering other core network functions unaware of and incapable of independently handling secured NAS signalling originating from the UE.

To address the above problem, the present disclosure provides techniques that enable security context establishment and coordination for the secondary NF node in the distributed NAS architecture. In the disclosed approach, the secondary NF node is configured to determine whether a security context with the UE already exists. Further, based on that determination, to retrieve a previously established shared or primary security context, the secondary NF node derives an NF specific security context using authentication based or key derivation mechanisms, or rederives an existing context during mobility or network reconfiguration events. The present disclosure further supports signalling to the UE to indicate whether a shared security context or an NF specific security context is to be used for subsequent communication. Therefore, the present disclosure enables a coordinated and efficient NAS security handling between the UE and multiple network functions. These mechanisms improve flexibility in NAS security management, reduce unnecessary signalling and reauthentication, and support distributed core network deployments while remaining compatible with existing NAS signalling principles.

In the following detailed description of various example embodiments of the disclosure, reference is made to the accompanying drawings that form a part hereof, and in which are shown by way of illustration of various embodiments in which the disclosure may be practiced. It is to be understood that various embodiments may be utilized and that changes may be made without departing from the scope of the present disclosure. The following description is, therefore, not to be taken in a limiting sense.

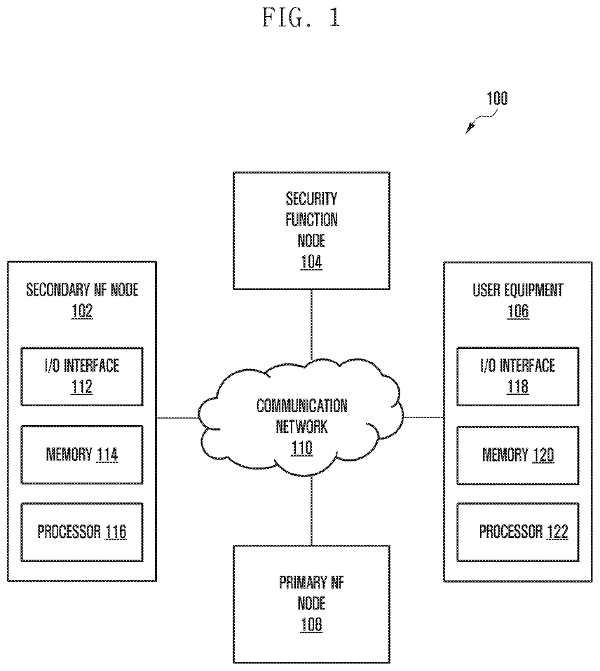

FIG. 1 is a block diagram illustrating an example environment for establishing security context in a distributed Non-Access Stratum (NAS), according to various example embodiments.

FIG. 1 illustrates an example environment for establishing and managing security contexts in a distributed Non-Access Stratum (NAS) based communication network, in accordance with embodiments of the present disclosure. As illustrated, the environment 100 includes a User Equipment (UE) 106, a primary Network Function (NF) node 108, a secondary NF node 102, and a Security Function (SF) node 104, all interconnected through a communication network 110. The NF nodes comprises an Input/Output (IO) interface 112, a memory 114, and a processor (e.g., including processing circuitry) 116 configured to support NAS signaling and security related operations. The UE 106 comprises an Input/Output (IO) interface 118, a memory 120, and a processor (e.g., including processing circuitry) 122 configured to support NAS signaling and security related operations. The UE 106 is configured to initiate NAS procedures and exchange NAS messages with core network functions via the communication network 110. While the primary NF node 108 acts as an initial NAS anchor for authentication related procedures, and the secondary NF node 102 handles NAS procedures associated with specific services or functions.

The UE 106 communicates NAS service messages intended for the secondary NF node 102 either directly or through the primary NF node 108 via the communication network 110. The secondary NF node 102 is configured to process the received NAS messages and to interact with the Security Function (SF) node 104 to obtain security related information, such as existing security contexts or keying details. The SF node 104 supports authentication related services and maintains security context information that may be accessed by the network functions as required. Based on the received NAS messages and security information obtained from the SF node 104, the secondary NF node 102 coordinates secure NAS communication with the UE 106. Therefore, the interaction between the UE, multiple NFs, and the security infrastructure in the distributed NAS environment is established.

In an embodiment, the example environment 100 may be implemented in a sixth generation (6G) communication system, which is expected to support highly distributed, service oriented, and cloud native core network architectures. In such 6G systems, multiple network functions may be instantiated dynamically and may require direct, secure interaction with the UE 106 at the NAS level. The present disclosure is applicable to these 6G environments by enabling NAS security establishment, reuse, and coordination across a plurality of network functions, including the primary NFs and the secondary NFs, while supporting mobility, network-function instance changes, and policy-driven security behavior. A person skilled in the art may appreciate that by accommodating distributed NAS security handling, the disclosed mechanisms align with architectural requirements anticipated for 6G systems, such as enhanced scalability, service differentiation, and fine-grained security control across heterogeneous NFs.

The secondary NF node 102 is configured to receive an encoded service message associated with the NAS procedure. The encoded service message is intended for establishing an NF specific security context for the secondary NF node 102. In an embodiment, the encoded service message may be received from one of, the UE 106 or the primary NF node 108. The encoded service message corresponds to one of, a plain NAS message, a message derived from the primary security context, a message derived from a Key Derivation Function (KDF) identifier, and a message derived from the NF specific security context. In an embodiment, the encoded service message comprises a first portion encrypted with a first security context associated with the primary NF node and a second portion encrypted with a second security context associated with the secondary NF node. This may occur when the encoded service message is transmitted to the primary NF node, and the encoded service message corresponds to a message derived from the NF specific security context. Upon receiving the encoded service message, the secondary NF node 102 may be configured to determine whether a security context is already established between the UE 106 and the secondary NF node 102. The determination may be based on one of, information included in the encoded service message or a query to a Security Function (SF) storing a primary security context. For example, by examining security-related information included in the encoded message, such as a key set identifier, security header type, or message type, or by querying the SF node 104 that maintains security context information. In an embodiment, determining the establishment of the security context comprises identifying a common security context between the UE and the secondary NF node based on the information included in the encoded service message comprising a Key Set Identifier (KSI), a security header type and a message type

In an embodiment, the secondary NF node 102 may retrieve a previously established primary or shared security context associated with the UE 106. The previously established primary or shared security context may be created as a result of a primary authentication and key agreement procedure with the primary NF node 108. For example, when the UE 106 initially registers with the primary NF node 108 for example AMF, the primary NF node 108 will perform the primary authentication and key agreement procedure and will further derive the security context. The derived security context will be stored in the SF node 104. The stored security context may be accessed by any other secondary NF node which may be authorized to use the data. In an embodiment, the primary NF node 108 which has established the initial security context with the UE 106 may broadcast the established security over Service Based Interface (SBI) which may be utilized by the other secondary NF nodes that are being selected as possible network functions the UE 106 may wish to interact with.

Therefore, when the UE 106 contacts the secondary NF node 102 for respective services, the UE 106 may send the encoded service message to the secondary NF node 102 using the security context derived with the primary NF node 108. The secondary NF node 102 on identifying the security association is not yet available with the UE 106, it will fetch it from the SF node 104. In an embodiment, the SF node may correspond to one of, Security Anchor Function (SEAF), Authentication Server Function (AUSF), Unified Data Management (UDM), Unified Data Repository (UDR), and the like.

In an example embodiment of the present disclosure, both the UE 106 and the network maintain the established security contexts for as long as the UE 106 remains registered with the same network and the corresponding NF node 102. Upon an inter-system change, such as a transition to a different Radio Access Technology (RAT) or public land mobile networks (PLMN), any secondary security context may be deemed invalid and, accordingly, may be deleted from both the UE and network contexts. In the event of a UE power cycle, the UE 106 may retain the primary security context, while the secondary security context may either be retained or deleted based on implementation-specific considerations. Further, in scenarios involving UE non-reachability, a secondary NF may maintain the corresponding security context for a predefined (e.g., specified) duration, for example using a timer mechanism, upon expiry of which the stored security context is deleted from the UE context.

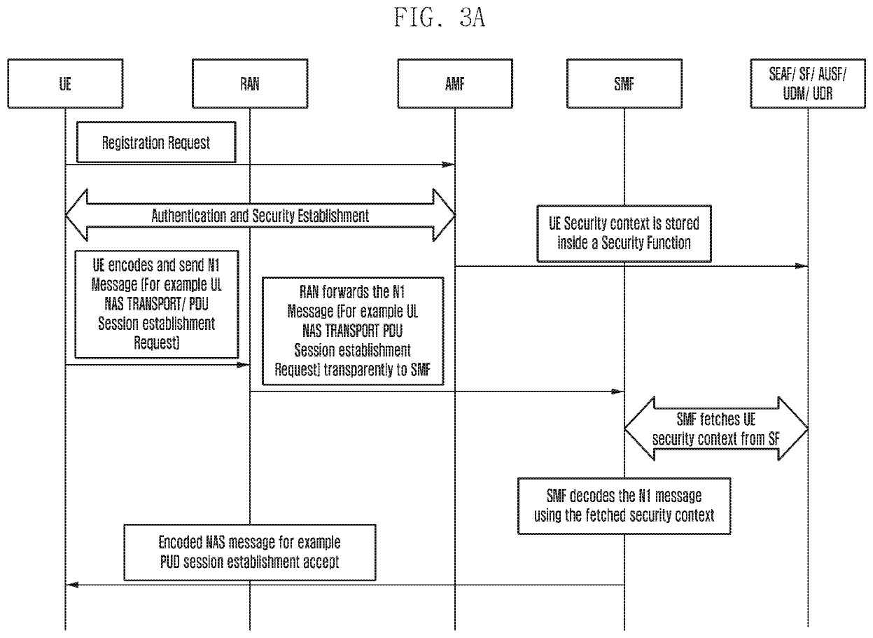

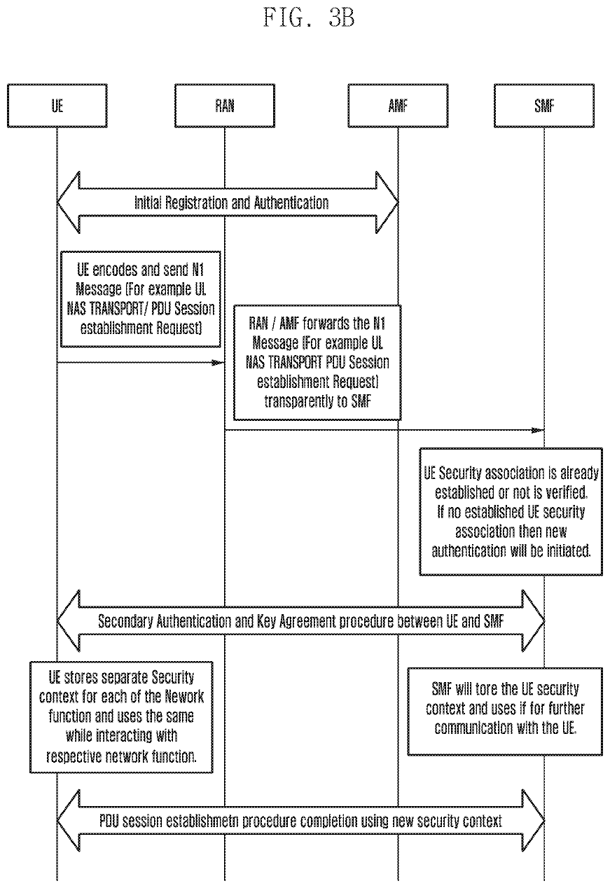

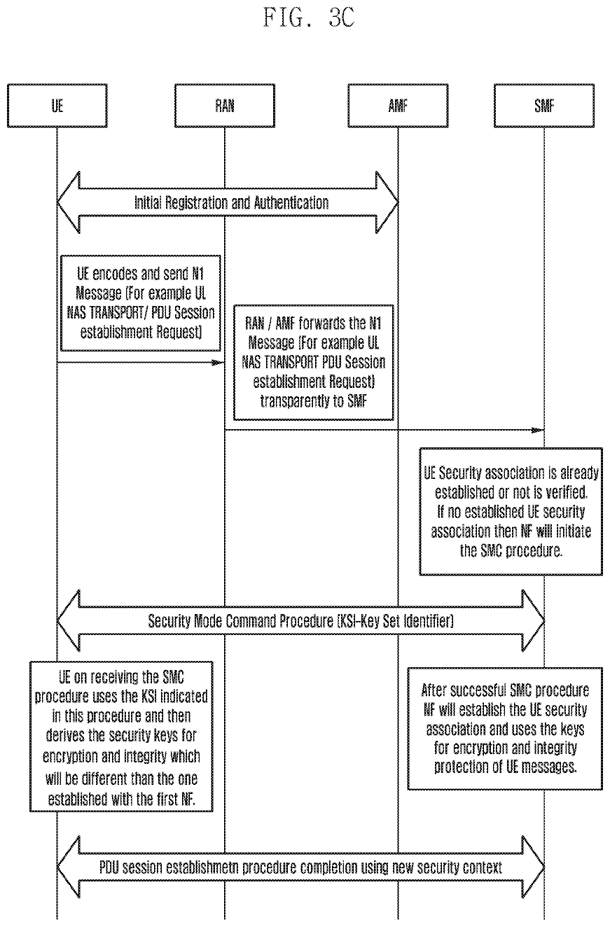

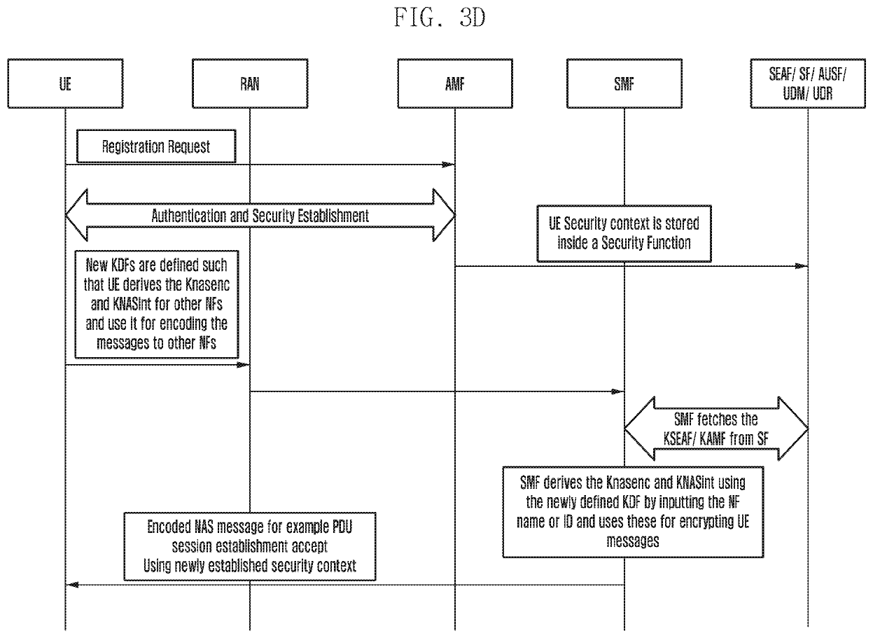

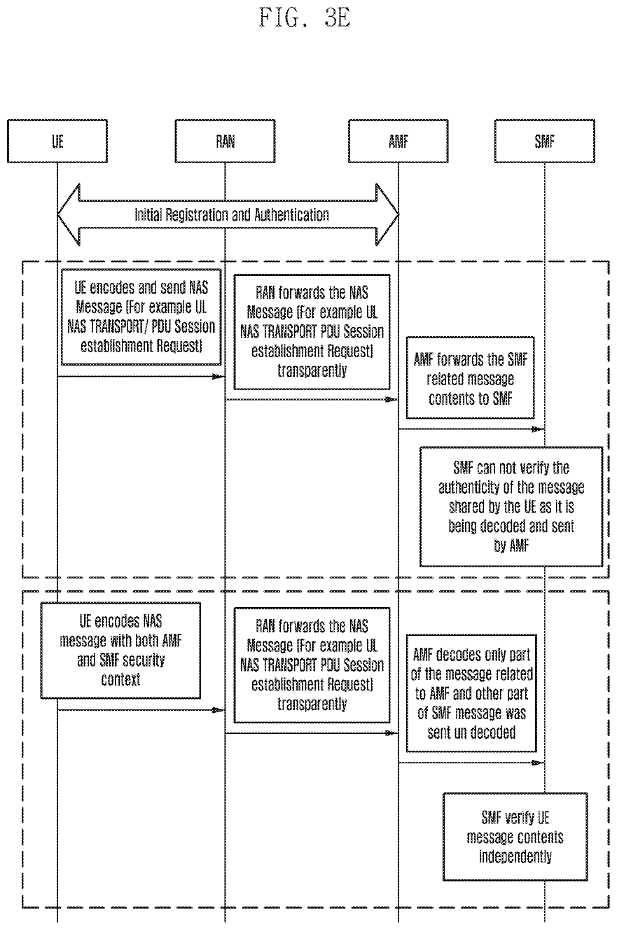

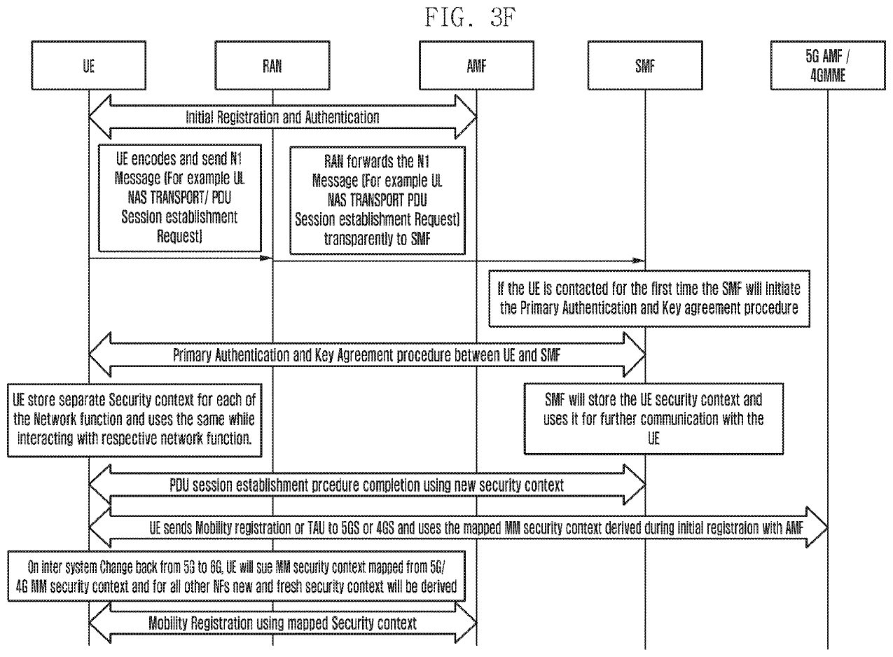

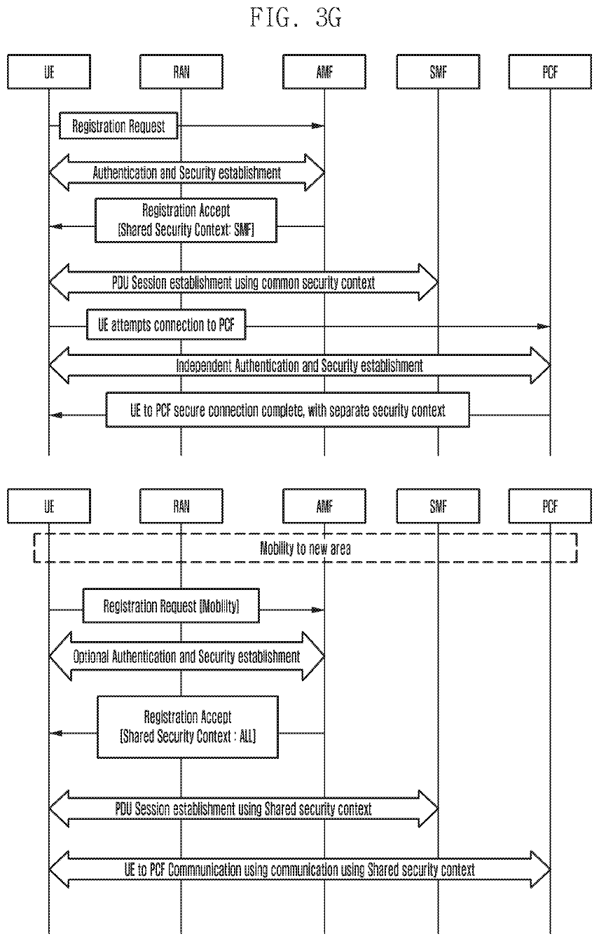

FIG. 3A is a signal or call flow diagram illustrating example establishment of a security context according to various example embodiments. FIG. 3A illustrates an example embodiment in which the common or shared UE security context is made available across multiple network functions within a next-generation (e.g., 6G) core network. As depicted in the call flow, the UE 106 initially transmits a registration request via the RAN to the primary NF node 108, such as the AMF. The AMF performs primary authentication and key agreement procedures with the UE and derives the UE security context. The derived security context is not retained solely within the AMF but is stored in, or made accessible through, the SF node 104 or a shared security repository. The SF node 104 may be implemented as a new logical network function or may be co-located with or integrated into an existing network function, such as the AMF, an Authentication Server Function (AUSF), or a unified data repository (e.g., UDM/UDR). Following establishment of the shared security context, the UE 106 transmits a NAS message, such as a PDU session establishment request, which is forwarded by the RAN to the secondary NF node 102, such as a Session Management Function (SMF), without requiring NAS termination at the AMF. Upon receiving the NAS message, the SMF determines that the UE security context required to decode the message is not locally available and, in response, retrieves the UE security context from the security function over a service based interface. Using the retrieved security context, the SMF successfully decodes and processes the NAS message and generates an appropriate encoded NAS response that is sent back to the UE 106. As illustrated, this example embodiment enables multiple authorized network functions to access a common UE security association, thereby allowing the UE 106 to securely interact with different network functions directly while maintaining NAS security continuity and eliminating the limitations of centralized NAS termination.

In an embodiment, when an independent security association is required, the secondary NF node 102 may initiate, in coordination with the UE 106, either a secondary authentication and key agreement procedure or a Security Mode Command (SMC) procedure to derive an NF specific security context. In an embodiment, the NF specific security context comprises freshly derived integrity and cipher keys, a new KSI identifying the NF specific security context, and integrity and ciphering algorithm identifiers. Once the security context is established, the secondary NF node 102 may be able to securely process and decode the encoded service messages. Therefore, using the secondary authentication and key agreement procedure both the UE 106 and the secondary NF node 102 may derive a new security context which is independent of the security context established with the primary NF node 108. In an embodiment, since the secondary NF node 102 may use a different KSI and algorithms, the keys used for encryption and integrity of messages exchanged between the UE 106 and the secondary NF node 102 may be ciphered independently. Accordingly, both the UE 106 and the secondary NF node 102 may store the new security context in the UE 106 and the secondary NF node 102. The new security context may be accessed and used for further communication between these two entities, the UE 106 and the secondary NF node 102.

FIG. 3B is a signal flow diagram illustrating an example of establishment of a security context according to various example embodiments. FIG. 3B illustrates an example in which independent UE security contexts are established for each NF that the UE 106 interacts with. As shown in the call flow, the UE 106 initially performs registration and primary authentication with the primary NF node 108, such as the AMF, via the RAN. During this initial procedure, the primary UE security context is derived and used to establish secure communication between the UE 106 and the primary NF node 108. When the UE 106 initiates interaction with the secondary NF node 102, such as the SMF, the UE 106 transmits the NAS message that may be encoded using the initially derived security context or, transmitted as the NAS message without applying security protection associated with the secondary NF node 102. Upon receipt of the NAS message, the secondary NF node 102 determines whether a valid UE security association already exists. If such a security association is not available or is not verified, the secondary NF node 102 initiates a secondary authentication and key agreement procedure directly with the UE 106. As depicted in the figure, this secondary procedure results in the derivation of a new and independent security context that is distinct from the security context established with the primary NF node 108. Both the UE and the secondary NF node 102 store the newly derived security context and subsequently use it to protect further NAS signalling exchanged between them, such as completion of a PDU session establishment procedure. This example enables each network function to maintain its own independent security association with the UE 106, thereby eliminating/reducing dependency on a centralized security context while preserving secure NAS communication in the distributed core network architecture.

FIG. 3C is a signal flow diagram illustrating an example of establishment of a security context according to various example embodiments. FIG. 3C illustrates an example in which the secondary NF node 102 establishes its own security context with the UE 106 by executing a SMC procedure. As depicted, the UE 106 initially performs registration, authentication, and primary key agreement with the primary NF node 108, such as the AMF, resulting in the derivation of an initial UE security context that secures NAS communication between the UE 106 and the primary NF node 108. When the UE 106 initiates interaction with the secondary NF node 102, such as the SMF, the UE 106 transmits the NAS message that may be encoded using the initial security context or transmitted as the plain NAS message without applying secondary security protection. Upon receiving the NAS message, the secondary NF node 102 determines that a valid security association has not yet been established. In response, the secondary NF node 102 initiates the SMC procedure with the UE 106, during which a different KSI and one or more algorithm identifiers are selected. Through this procedure, the UE 106 and the secondary NF node 102 derive a new and separate security context that is cryptographically independent of the security context established with the primary NF node 108. As shown in FIG. 3C, the newly derived security context is then used to apply integrity protection and encryption to subsequent NAS messages exchanged between the UE 106 and the secondary NF node 102, such as completion of a PDU session establishment procedure. Both the UE 106 and the secondary NF node 102 store this independent security context and use it for ongoing communication.

In an embodiment, for retrieving one of, the primary security context or the shared security context, the secondary NF node 102 is further configured to derive the NF specific security context using a KDF identifier, when the encoded service message corresponds to a message derived from the KDF identifier. According to the current embodiment, prior to the UE 106 interacting with the secondary NF node 102, for example the AMF, the UE 106 sends the encoded service message as a message derived from newly defined KDFs by inputting the NF name or ID along with SN name and additional details such as, UL/DL NAS counts. Therefore, the secondary NF node 102 may identify that the UE 106 has encoded the message and thus interacts with the SF node 104 and then obtains the master key. Using newly defined KDFs, the secondary NF node 102 may derive the new security context which is independent of the security context established with the primary NF node 108. Accordingly, both the UE 106 and the secondary NF node 102 may store the new security context in the UE 106 and the secondary NF node 102. The new security context may be accessed and used for further communication between these two entities, the UE 106 and the secondary NF node 102.

FIG. 3D is a signal flow diagram illustrating an example of establishment of a security context according to various example embodiments. FIG. 3D illustrates an example in which new KDFs are defined to enable the UE 106 to derive integrity and ciphering keys for interaction with NFs other than the primary NF node 108. As shown, the UE 106 initially performs registration, authentication, and primary key agreement with the primary NF node 108, such as the AMF, via the RAN. This process results in the establishment of a primary UE security context, which is stored in or made accessible through a SF node 104 or security repository. As part of this embodiment, new KDFs are defined at the UE 106 and the primary NF node 108 such that the UE 106 can subsequently derive NAS security keys by inputting additional parameters, such as the target network function identifier or name, serving network identifier, and uplink and downlink NAS counts, rather than reusing the primary NAS keys. When the UE 106 initiates interaction with the secondary NF node, such as the SMF, the UE 106 encodes and transmits the NAS message using keys derived via the newly defined KDFs that are specific to the target network function (the secondary NF node 102). Upon receiving the encoded NAS message, the secondary NF node 102 determines that the message has been protected using NF specific derived keys and retrieves the relevant master or root key material from the SF node 104. Using the same newly defined KDFs and corresponding inputs, the secondary NF node 102 independently derives matching integrity and ciphering keys, thereby establishing a new security context that is cryptographically independent of the security context established with the primary NF node 108. Both the UE 106 and the secondary NF node 102 store and subsequently use this independently derived security context for further NAS communication.

In existing approaches, if the UE 106 wishes to send the encoded service message to the secondary NF node 102, then the UE 106 may encode the message with security details associated with the primary NF node 108 and sends it to a Radio Access Network (RAN) and the RAN may then forward it to the primary NF node 108, transparently. Thereafter, the primary NF node 108 may decode the content of the message and the message may then be forwarded to the secondary NF node 102. However, according to the above described example approach, there may exist a possibility where the primary NF node 108 may modify the content of the message and the secondary NF node 102 may not verify the same. Therefore, according to various embodiments, prior to causing the establishment of the security context, the secondary NF node 102 may be configured to verify the encoded service message. This may typically occur when the encoded service message is received from the primary NF node 108 and when the encoded service message corresponds to a message derived from the NF specific security context. According to an example embodiment, the message comprises a portion encrypted with the NF specific security context associated with the secondary NF node. Thus, if a single message carries payload or message contents belonging to a plurality of NFs, then each NF related message content may be encrypted or integrity protected with respective NF specific security context. Hence each of the plurality of NFs may independently validate the encoded service messages from the UE 106 and thus be able to achieve a zero trust policy based distributed network architecture.

In an embodiment, the secondary NF node 102 may support continuity of NAS security when a serving instance of the secondary NF node 102 changes due to user mobility, network reconfiguration, or dynamic scaling of NF instances. Such a change may occur, for example, when the UE 106 moves between coverage areas served by different instances of the same NF or when the network reassigns the UE 106 to a different instance for load balancing or resilience purposes. Upon detecting the change in the serving instance, the secondary NF node may determine whether an existing NF specific security context associated with the UE 106 is available locally. When the NF specific security context is not locally available at the new serving instance, the secondary NF node may perform continuity mechanisms. In an embodiment, the secondary NF node 102 may retrieve the previously established NF specific security context from the SF node 104 or from a prior instance of the secondary NF node 102 that previously served the UE 106. In an embodiment, instead of retrieving stored session keys, the secondary NF node 102 may re-derive the NF specific security context using stored security context parameters. The security context parameters may include, for example, a network function identifier, a serving network name, and uplink and downlink NAS count values associated with the UE 106. By retrieving or re-deriving the NF specific security context, the secondary NF node 102 maintains security continuity for NAS communication without requiring a new authentication or security mode establishment procedure, thereby reducing signalling overhead and preserving session continuity during mobility or network reconfiguration events.

FIG. 3E is a signal flow diagram illustrating an example of establishment of a security context according to various example embodiments. FIG. 3E illustrates an example in which a single NAS message is encoded using multiple security contexts when the message carries payloads or information destined for multiple NFs. As shown, the UE 106 initially performs registration, authentication, and primary key agreement with the primary NF node 108, such as the AMF, resulting in the establishment of the first UE security context. As depicted in the lower portion of the figure, the UE 106 encodes the single NAS message using multiple, NF specific security contexts, such that each portion of the message corresponding to a given NF is protected with the integrity and ciphering keys associated with the respective NF. The RAN forwards the NAS message transparently, and the AMF decodes only the portion of the message protected with its own security context, while leaving intact the portions protected for other NFs. The SMF, upon receiving the forwarded message, is able to independently decode, authenticate, and verify the UE message content using its own security context, without relying on trust in the AMF's decoding or modification. This example enables multiple network functions to independently validate UE messages carried within a single NAS transmission.

In an embodiment, the secondary NF node 102 further determines whether subsequent NAS communication with the UE 106 should use the shared security context or the NF-specific security context. This determination may be based on network security policy, trust level associated with the secondary network function, service requirements, deployment configuration, or changes in network topology or mobility conditions. For example, in an example scenario, reuse of the shared security context established with the primary NF node 108 may be sufficient, while in other scenarios the secondary NF node 102 may require isolation through the NF-specific security context. Based on this determination, the secondary NF node 102 transmits an indication message to the UE 106, specifying whether the shared security context or the NF-specific security context is to be used for subsequent NAS communication with the secondary NF node 102. The indication may be transmitted after detection of a serving instance change, after retrieval or re-derivation of the NF-specific security context, or when a change in security policy necessitates informing the UE 106 of the applicable security-context mode. Upon receiving the indication, the UE 106 may select the indicated security context and encodes subsequent NAS messages accordingly. This signalling mechanism enables coordinated security behavior between the UE 106 and the secondary NF node 102. Therefore, the current embodiment ensures that NAS messages are protected using the appropriate security context in the distributed NAS environment.

FIG. 3F is a signal flow diagram illustrating an example of establishment of a security context according to various example embodiments. FIG. 3F illustrates an example in which deriving and mapping UE security contexts during inter-system mobility is shown. As depicted, the UE 106 initially performs registration and primary authentication with the primary NF node 108, such as the AMF, thereby establishing the primary security context between the UE 106 and the primary NF node 108. The UE 106 then initiates communication with the secondary NF node 102, such as the SMF, by transmitting the NAS message, which is forwarded transparently by the RAN. If the SMF interacts with the UE 106 for the first time and no valid security association exists, the SMF initiates an authentication and key agreement procedure directly with the UE 106. Therefore, a new and independent security context specific to the UE-SMF association is established. Both the UE 106 and the SMF store this security context and use it to complete subsequent procedures, such as PDU session establishment. The figure further illustrates handling of inter-system mobility. When the UE 106 transitions from the 6G system to a legacy system, such as 5G or 4G, the UE 106 performs a mobility registration or Tracking Area Update (TAU) toward the legacy core using a mapped mobility management security context derived from the security context established during the initial registration. The mapped security context enables secure continuity across systems without requiring full re-authentication in the legacy system. Upon a subsequent transition back from the legacy system to the 6G system, the UE 106 maps the legacy mapped security context to derive a corresponding 6G security context for mobility registration with the 6G AMF. For other NFs within the 6G system, the UE 106 may either reuse previously stored native security contexts, if available, or establish new security contexts as needed. In this example, the present disclosure enables secure, efficient inter-system mobility by providing systematic derivation and mapping of security contexts across heterogeneous access systems while preserving independent security associations between the UE 106 and individual network functions.

FIG. 3G is a signal flow diagram illustrating an example of establishment of a security context according to various example embodiments. FIG. 3G illustrates an example in which explicit signalling is used to indicate whether the shared security context or the independent security context is applied between the UE 106 and one or more NFs in a distributed core network architecture. As shown, the UE 106 initially performs registration and authentication with the primary NF node 108, such as the AMF, resulting in establishment of the UE security context. As part of the registration procedure, the AMF provides an explicit indication, for example in a registration accept or other NAS control message, identifying which network functions are authorized to use the shared security context and which require independent security context establishment. In one scenario depicted in the figure, the NF informs the UE 106 that only a limited set of NFs, such as the SMF, supports the shared security context, while other NFs, such as a Policy Control Function (PCF), require separate authentication and key agreement procedures. The figure further illustrates dynamic policy adaptation as the UE 106 moves between network areas or deployment scenarios. When the UE 106 enters a new area in which the network supports a common security context across multiple NFs, the network notifies the UE 106 via NAS signalling that the shared security context is applicable to all relevant NFs. As a result, the UE 106 may use common security keys to securely establish and continue communication with multiple NFs, including SMF and PCF, without performing independent authentication for each. Conversely, when the network function is not designated for shared security usage, the UE 106 initiates an independent authentication and security establishment procedure with that NF and maintains a separate security context for subsequent communication. Through this explicit signalling mechanism, the present disclosure enables flexible coexistence of shared and independent security contexts, allowing the network to implement deployment specific security policies.

Upon obtaining the security context based on any one of the above described embodiments, the secondary NF node 102 may be configured to decode the encoded service message using one of, the primary security context, the shared security context, or the NF specific security context.

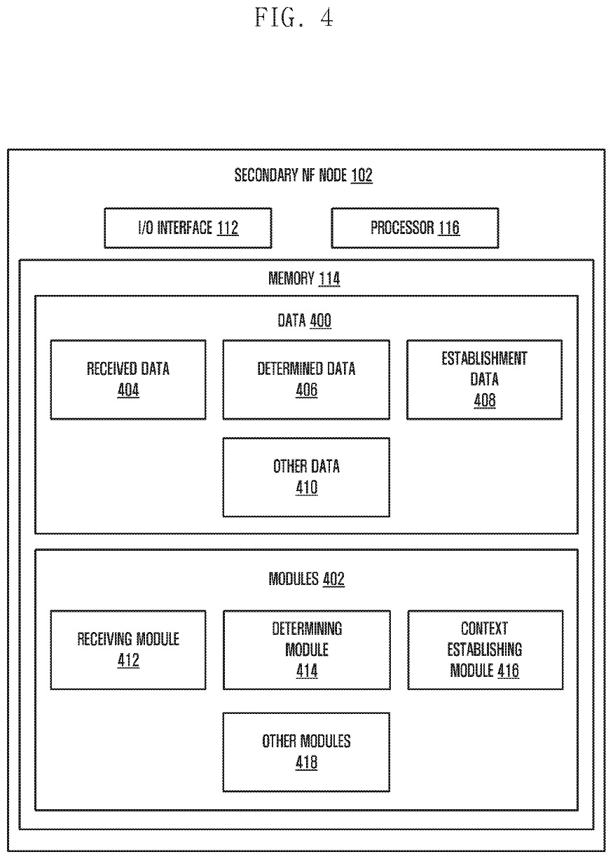

FIG. 4 is a block diagram illustrating an example configuration of a secondary Network Function (NF) node, according to various example embodiments.

FIG. 4 illustrates an example internal architecture of the secondary NF node 102 in accordance with various embodiments. The secondary NF node 102 may include at least one Central Processing Unit (“CPU” or “processor”) 116 and a memory 114 storing instructions executable by the at least one processor 116. The processor 116 may include various processing circuitry and comprise at least one data processor for executing program components for executing user or system-generated requests. The memory 114 is communicatively coupled to the processor 116. The secondary NF node 102 further comprises an Input/Output (I/O) interface 112. The I/O interface 112 is coupled with the processor 116 through which an input signal or/and an output signal is communicated. The processor 116 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various embodiments, the secondary NF node 102 may include data 400 and modules (e.g., including various circuitry and/or executable program instructions) 402. As an example, the data 400 may be stored within the memory 114 associated with the secondary NF node 102. In various embodiments, data 400 may include, for example, received data 404, determined data 406, establishment data 408 and other data 410. In various embodiments, the data 400 may be stored in the memory 114 in form of various data structures. The secondary NF node 102 may include more or less modules, and the illustrated modules must not be considered as a limitation.

The received data 404 comprises the encoded service message associated with the NAS procedure. The message may be sent by one of, the UE 106 or the primary NF node 108. In an embodiment, the message may correspond to one of, the plain NAS message, the message derived from the primary security context, the message derived from the KDF identifier, and the message derived from the NF specific security context.

The determined data 406 comprises a condition corresponding to whether the security context is already established between the UE 106 and the secondary NF node 102.

The establishment data 408 comprises the security context obtained by performing any one of security context establishment procedures.

The other data 410 may be stored data, including temporary data and temporary files, generated by the modules 402 for performing the various functions of the secondary NF node 102.

In an embodiment, the data 400 in the memory 114 are processed by the one or more modules 402 present within the memory 114 of the secondary NF node 102.

One or more modules 402 along with the data 400, functions to establish security context in a distributed NAS. In one implementation, the one or more modules 402 may include, but are not limited to, a receiving module 412, a determining module 414, a context establishing module 416 and one or more other modules 418.

In an embodiment, the one or more modules 402 may be implemented as dedicated units. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. In various implementations, the one or more modules 402 may be communicatively coupled to the processor 116 for performing one or more functions of the secondary NF node 102. The modules 402 when configured with the functionality defined in the present disclosure will result in a novel hardware.

In an embodiment, the receiving module 412 may be configured to receive the encoded service message associated with the NAS procedure intended for establishing the NF specific security context for the secondary NF node 102. In an embodiment, the NF specific security context comprises the freshly derived integrity and cipher keys, the new KSI identifying the NF specific security context, and the integrity and ciphering algorithm identifiers. The encoded service message is stored in the received data 402 and sent to the determining module 414.

In an embodiment, the determining module 414 may be configured to receive the received data 402 and determine whether the security context is already established between the UE 106 and the secondary NF node 102. The determining module 414 may perform the determination based on one of, information included in the encoded service message or the query to SF node storing the primary security context. In an embodiment, the determining module 414 may determine by identifying the common security context between the UE 106 and the secondary NF node 102 based on the information included in the encoded service message comprising the KSI, the security header type and the message type. The result obtained based on determination is stored in the determined data 406 and sent to the context establishing module 416.

In an embodiment, the context establishing module 416 may be configured to receive the determined data 406 and cause the establishment of the security context by performing retrieval, from the SF node 104, of one of, the primary security context or the shared security context, previously established between the UE 106 and the primary NF node 108. The UE 106 may previously initiate the primary authentication and key agreement procedure with the primary NF node 108. In an embodiment, the context establishing module 416 may retrieve one of, the primary security context or the shared security context by deriving the NF specific security context using the KDF identifier, when the encoded service message corresponds to the message derived from the KDF identifier. The establishment of the security context may further be caused by initiating, with the UE 106, one of, the secondary authentication and key agreement procedure, or the SMC procedure to derive the NF specific security context. Further, the primary security context or the shared security context and the NF specific security context may be stored in establishment data 408 and may be sent to other modules 418, when needed.

In an embodiment, various other modules 418 may include a verifying module configured to verify the encoded service message, prior to causing the establishment of the security context. The verifying module may perform the verification when the encoded service message may be received from the primary NF node 108 and when the encoded service message corresponds to the message derived from the NF specific security context. The message may comprise of the portion encrypted with the NF specific security context associated with the secondary NF node 102. The verified details may then be stored in other data 410 and be sent to the context establishing module 416.

In an embodiment, the other modules 418 may further include a detecting module configured to detect the change in the serving instance of the secondary NF node 102 due to the UE mobility or the network reconfiguration. The detected change may be stored in the other data 410 and be sent to the context establishing module 416.

In an embodiment, the context establishing module 416 may be configured to receive the detected data from the detecting module. The context establishing module 416 may be further configured to retrieve the NF specific security context from the SF node 104 or from a previous instance of the secondary NF node 102. Further, the context establishing module 416 may be configured to re-derive the NF specific security context using stored security context parameters. In an embodiment, the stored security context parameters may comprise of the network function identifier, the serving network name, the uplink NAS count value, and the downlink NAS count value.

In an embodiment, the other modules 418 may include a transmitting module configured to transmit the indication message to the UE 106. The indication message may specify whether the shared security context or the NF specific security context is to be used for communication with the secondary NF node 102.

In an embodiment, the other modules 418 may further include a decoding module configured to decode the encoded service message using one of, the primary security context, the shared security context, or the NF specific security context, retrieved from the establishment data 408.

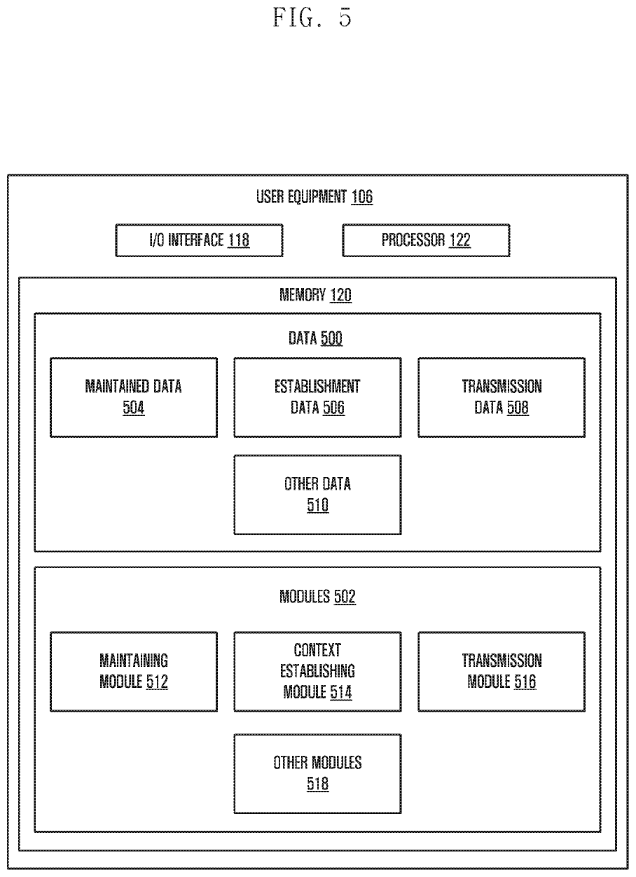

FIG. 5 is a block diagram illustrating an example configuration of a UE, according to various example embodiments.

FIG. 5 illustrates an example internal architecture of the UE 106 in accordance with various example embodiments. The UE 106 may include at least one Central Processing Unit (“CPU” or “processor”) 122 and a memory 120 storing instructions executable by the at least one processor 122. The processor 122 may comprise at least one data processor for executing program components for executing user or system-generated requests. The memory 120 is communicatively coupled to the processor 122. The UE 106 further comprises an Input/Output (I/O) interface 118. The I/O interface 118 is coupled with the processor 122 through which an input signal or/and an output signal is communicated. The processor 122 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various implementations, the UE 106 may include data 500 and modules (e.g., including various circuitry and/or executable program instructions) 502. As an example, the data 500 may be stored within the memory 120 associated with the UE 106. In various embodiments, data 500 may include, for example, maintained data 504, establishment data 506, transmission data 508 and other data 510. In various embodiments, the data 500 may be stored in the memory 120 in form of various data structures. The UE 106 may include more or less modules, and the illustrated modules must not be considered as a limitation.

The maintained data 504 comprises the plurality of security contexts associated with the plurality of NFs comprising the primary NF node 108 and the plurality of secondary NF nodes.

The establishment data 506 comprises the primary security context established with the primary NF node 108.

The transmission data 508 comprises the encoded service message associated with the NAS procedure. In an embodiment, the message may correspond to one of, the plain NAS message, the message derived from the primary security context, the message derived from the KDF identifier, and the message derived from the NF specific security context. In an embodiment, the encoded service message comprises the first portion encrypted with the first security context associated with the primary NF node and the second portion encrypted with the second security context associated with the secondary NF node. This typically occurs when the encoded service message is transmitted to the primary NF node, and the encoded service message corresponds to the message derived from the NF specific security context.

Various other data 510 may be stored data, including temporary data and temporary files, generated by the modules 502 for performing the various functions of the UE 106.

In an embodiment, the data 500 in the memory 120 are processed by the one or more modules 502 present within the memory 120 of the UE 106.

One or more modules 502 along with the data 500, functions to establish security context in a distributed NAS. In an example implementation, the one or more modules 502 may include, but are not limited to, a maintaining module 512, a context establishing module 514, a transmission module 516 and various other modules 518.

In an embodiment, the one or more modules 502 may be implemented as dedicated units. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. In some implementations, the one or more modules 402 may be communicatively coupled to the processor 122 for performing one or more functions of the UE 106. The modules 502 when configured with the functionality defined in the present disclosure will result in a novel hardware.

In an embodiment, the maintaining module 512 may be configured to maintain the plurality of security contexts associated with the plurality of NFs comprising the primary NF node 108 and the plurality of secondary NF nodes. The maintained plurality of security contexts may be stored in the maintained data 504 and may be sent to the context establishing module 514.

In an embodiment, the context establishing module 514 may be configured to receive the maintained data 504 and may be further configured to establish the primary security context with the primary NF node 108 by initiating the primary authentication and key agreement procedure with the primary NF node 108. The established primary security context may be stored in the establishment data 506 and may be sent to the transmission module 516.

The transmission module 516 may be configured to receive the establishment data 506 and may be further configured to transmit the encoded service message associated with the NAS procedure intended for establishing one of, the shared security context, or the NF specific security context for the secondary NF node 102, to one of, the secondary NF node 102 or the primary NF node 108. In an embodiment, the shared security context corresponds to the primary security context which may be shared between the primary NF node 108 and the secondary NF node 102. In an embodiment, the NF specific security context comprises freshly derived integrity and cipher keys, the new KSI identifying the NF specific security context, and integrity and ciphering algorithm identifiers. In an embodiment, the transmission module may be configured to receive the indication message specifying whether the shared security context or the NF specific security context is to be used for communication with the secondary NF node 102, based on the change in the serving instance of the secondary NF node 102 due to UE mobility or network reconfiguration.

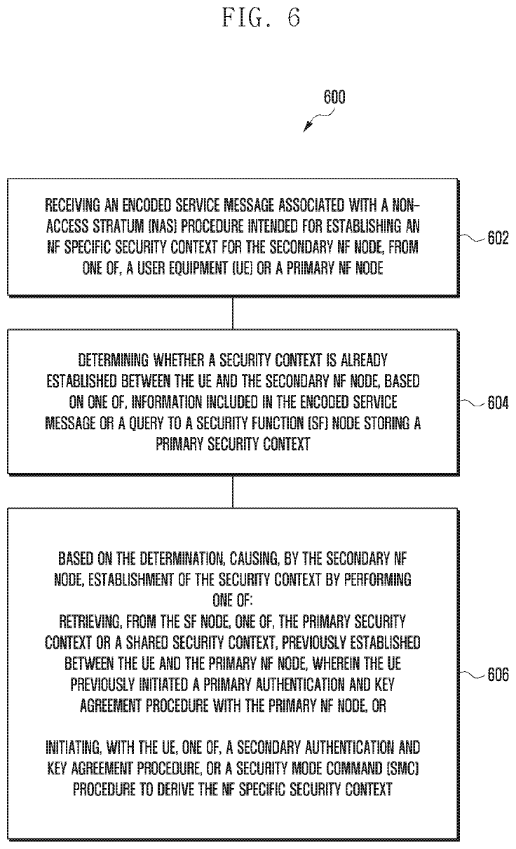

FIG. 6 is a flowchart illustrating an example method for establishing security context in a distributed Non-Access Stratum (NAS), according to various example embodiments.

As illustrated in FIG. 6, the method 600 comprises one or more blocks illustrating an example method of establishing security context in a distributed Non-Access Stratum (NAS), in accordance with various example embodiments. The method 600 may be described in the general context of computer-executable instructions. Generally, computer-executable instructions can include routines, programs, objects, components, data structures, procedures, modules, and functions, which perform functions or implement abstract data types.

The order in which the method 600 is described is not intended to be construed as a limitation, and any number of the described method blocks can be combined in any order to implement the method 600. Individual blocks may be deleted from the methods without departing from scope of the subject matter described herein. The method 600 can be implemented in any suitable hardware, software, firmware, or combination thereof.

At block 602, the method 600 may include receiving, by the secondary NF node 102, the encoded service message associated with the NAS procedure intended for establishing the NF specific security context for the secondary NF node 102, from one of, the UE 106 or the primary NF node 108. In an embodiment, the message may correspond to one of, the plain NAS message, the message derived from the primary security context, the message derived from the KDF identifier, and the message derived from the NF specific security context.

At block 604, the method 600 may include determining, by the secondary NF node 102, whether the security context is already established between the UE 106 and the secondary NF node 102, based on one of, the information included in the encoded service message or the query to the SF node 104 storing the primary security context. In an embodiment, the method further comprises identifying the common security context between the UE 106 and the secondary NF node 102 based on the information included in the encoded service message comprising the KSI, the security header type and the message type. In an embodiment, the NF specific security context comprises the freshly derived integrity and cipher keys, the new KSI identifying the NF specific security context, and the integrity and ciphering algorithm identifiers.

At block 606, the method 600 may include based on the determination, causing, by the secondary NF node 102, establishment of the security context by performing one of retrieving, from the SF node 104, one of, the primary security context or the shared security context, previously established between the UE 106 and the primary NF node 108. The UE 106 previously initiated the primary authentication and key agreement procedure with the primary NF node 108. In an embodiment, retrieving one of, the primary security context or the shared security context, further comprises deriving the NF specific security context using the KDF identifier, when the encoded service message corresponds to the message derived from the KDF identifier. In an embodiment, causing the establishment of the security context further comprises detecting the change in the serving instance of the secondary NF node 102 due to the UE mobility or network reconfiguration. Thereafter, based on the detection, performing one of retrieving the NF specific security context from the SF node 104 or from the previous instance of the secondary NF node 102. Followed by re-deriving the NF specific security context using stored security context parameters. Finally, the method comprises transmitting, to the UE 106, the indication message specifying whether the shared security context or the NF specific security context is to be used for communication with the secondary NF node 102. In an embodiment, the stored security context parameters may comprise of the network function identifier, the serving network name, the uplink NAS count value, and the downlink NAS count value.

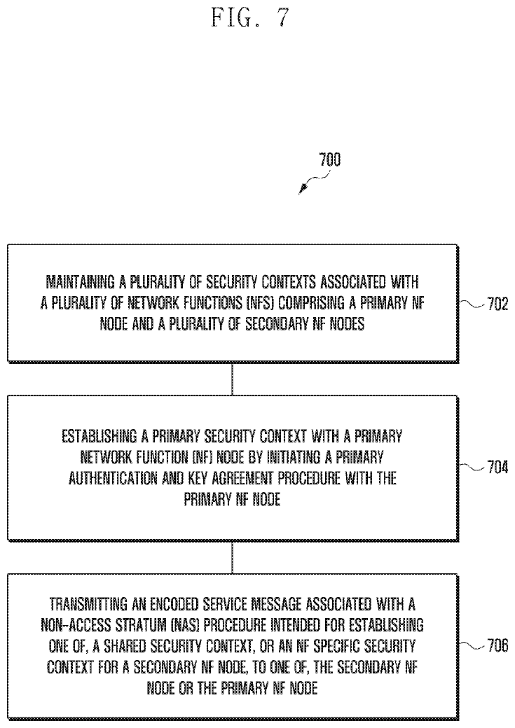

FIG. 7 is a flowchart illustrating an example method for establishing security context in a distributed Non-Access Stratum (NAS), according to various example embodiments.

As illustrated in FIG. 7, the method 700 comprises one or more blocks illustrating an example method of establishing security context in a distributed Non-Access Stratum (NAS), in accordance with various example embodiments. The method 700 may be described in the general context of computer-executable instructions. Generally, computer-executable instructions can include routines, programs, objects, components, data structures, procedures, modules, and functions, which perform functions or implement abstract data types.

The order in which the method 700 is described is not intended to be construed as a limitation, and any number of the described method blocks can be combined in any order to implement the method 700. Individual blocks may be deleted from the methods without departing from scope of the subject matter described herein. The method 700 can be implemented in any suitable hardware, software, firmware, or combination thereof.

At block 702, the method 700 may include maintaining, by the UE 106, the plurality of security contexts associated with the plurality of NFs comprising the primary NF node 108 and the plurality of secondary NF nodes.

At block 702, the method 700 may include establishing, by the UE 106, the primary security context with the primary NF node 108 by initiating the primary authentication and key agreement procedure with the primary NF node 108.

At block 704, the method 700 may include transmitting, by the UE 106, the encoded service message associated with the NAS procedure intended for establishing one of, the shared security context, or the NF specific security context for the secondary NF node 102, to one of, the secondary NF node 102 or the primary NF node 108. In an embodiment, the NF specific security context comprises the freshly derived integrity and cipher keys, the new KSI identifying the NF specific security context, and integrity and ciphering algorithm identifiers. In an embodiment, the message may correspond to one of, the plain NAS message, the message derived from the primary security context, the message derived from the KDF identifier, and the message derived from the NF specific security context. In an embodiment, the encoded service message comprises the first portion encrypted with the first security context associated with the primary NF node and the second portion encrypted with the second security context associated with the secondary NF node. This typically occurs when the encoded service message is transmitted to the primary NF node, and the encoded service message corresponds to the message derived from the NF specific security context.

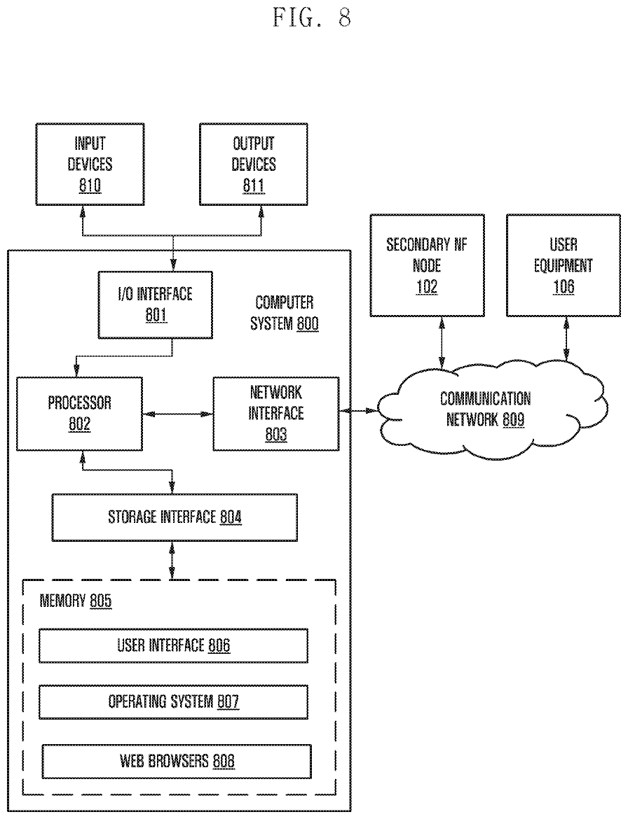

FIG. 8 is a block diagram illustrating an example configuration of a computer system for implementing various embodiments.

In various embodiments, FIG. 8 is a block diagram illustrating an example configuration of an example computer system 800 for implementing the present disclosure. In various embodiments, the computer system 800 can be the secondary NF node 102 that comprises a processor (also referred as a processor (e.g., including processing circuitry) 802 in FIG. 8) that is used for establishing security context in a distributed NAS. The processor 802 may include at least one data processor for executing program components for executing user or system-generated business processes. The processor 802 may include specialized processing units such as integrated system (bus) controllers, memory management control units, floating point units, graphics processing units, digital signal processing units, etc. The processor 802 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 802 may be disposed in communication with input devices 810 and output devices 811 via I/O interface 801. The I/O interface 801 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 801, computer system 800 may communicate with input devices 810 and output devices 811.

In various embodiments, the processor 802 may be disposed in communication with a communication network 809 via a network interface 803. The network interface 803 may communicate with the communication network 809. The network interface 803 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 803 and the communication network 809, the computer system 800 may communicate with the UE 106 via the communication network 110.

The communication network 809 can be implemented as one of the different types of networks, such as intranet or Local Area Network (LAN) and such within the organization. The communication network 809 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

The communication network 809 may include a variety of network devices, including routers, bridges, servers, computing devices, storage devices, etc. In various embodiments, the processor 802 may be disposed in communication with a memory 805 (e.g., RAM, ROM, etc. not shown in FIG. 8) via a storage interface 804. The storage interface 804 may connect to memory 805 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 805 may store a collection of program or database components, including, without limitation, a user interface 806, an operating system 807, a web browser 808 etc. In various embodiments, the computer system 800 may store user/application data, such as the data, variables, records, etc. as described in this disclosure. Such databases may be implemented as fault-tolerant, relational, scalable, secure databases such as Oracle or Sybase.

Operating system 807 may facilitate resource management and operation of computer system 800. Examples of operating systems include, without limitation, APPLE^{®}MACINTOSH® OS X®, UNIX®, UNIX-like system distributions (E.G., BERKELEY SOFTWARE DISTRIBUTION® (BSD), FREEBSD®, NETBSD® , OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like. User interface 806 may facilitate display, execution, interaction, manipulation, or operation of program components through textual or graphical facilities. For example, user interfaces may provide computer interaction interface elements on a display system operatively connected to computer system 800, such as cursors, icons, check boxes, menus, scrollers, windows, widgets, etc. Graphical User Interfaces (GUIs) may be employed, including, without limitation, Apple® Macintosh® operating systems'Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

The computer system 800 may implement web browser 808 stored program components. Web browser 808 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 808 may utilize facilities such as AJAX, DHTML, ADOBE® FLASH®, JAVASCRIPT®, JAVA®, Application Programming Interfaces (APIs), etc. The computer system 800 may implement a mail server stored program component. The mail server may be an Internet mail server such as Microsoft Exchange, or the like. The mail server may utilize facilities such as ASP, ACTIVEX®, ANSI® C++/C #, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In various embodiments, the computer system 800 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

One or more computer-readable storage media may be utilized in various example embodiments. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with various embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Disclosed herein is a method and system for establishing and managing security contexts in a distributed Non-Access Stratum (NAS) communication network. In existing cellular communication systems, NAS signalling and associated security procedures are centralized at a primary Network Function (NF) node. The primary NF node may correspond to NFs such as an access and mobility management function, with which a User Equipment (UE) establishes a single security context during authentication. Secondary NFs rely on the primary NFs for NAS security termination and message validation, and do not directly maintain security associations with the UE. This centralized approach limits flexibility in applying security policies which are NF-specific and introduces additional signalling overhead due to routing of NAS messages through a central entity. The existing approach also provides limited mechanisms to efficiently maintain security continuity when NF instances change due to mobility, scaling, or network reconfiguration.

To address the above problem, the present disclosure provides techniques that enable security context establishment and coordination for the secondary NF node in the distributed NAS architecture. In the disclosed approach, the secondary NF node is configured to determine whether a security context with the UE already exists. Based on that determination, to retrieve a previously established shared or primary security context, the secondary NF node derives an NF specific security context using authentication based or key derivation mechanisms, or rederives an existing context during mobility or network reconfiguration events. The present disclosure further supports signalling to the UE to indicate whether a shared security context or an NF specific security context is to be used for subsequent communication. Therefore, the present disclosure enables a coordinated and efficient NAS security handling between the UE and multiple network functions. These mechanisms improve flexibility in NAS security management, reduce unnecessary signalling and reauthentication, and support distributed core network deployments while remaining compatible with existing NAS signalling principles.

A description of an embodiment with several components in communication with each other does not imply that all such components are required. A variety of optional components are described to illustrate the wide variety of possible embodiments. When a single device or article is described herein, it will be apparent that more than one device/article (whether or not they cooperate) may be used in place of a single device/article. Where more than one device or article is described herein (whether or not they cooperate), it will be apparent that a single device/article may be used in place of the more than one device or article, or a different number of devices/articles may be used instead of the shown number of devices or programs. The functionality and/or the features of a device may be embodied by one or more other devices which are not explicitly described as having such functionality/features. Thus, various example embodiments of the disclosure need not include the device itself.

The various example embodiments described herein are non-limiting. Such embodiments can be combined in various combinations, although such combinations are not explicitly described a person skilled will appreciate possibility of such combinations.

The disclosure described various example embodiments, and it should be anticipated that on-going technological development will change the manner in which particular functions are performed. These examples are presented herein for purposes of illustration, and not limitation. The boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to those skilled in the relevant art(s) based on the teachings contained herein. Such alternatives fall within the scope and spirit of the disclosed embodiments. The terms “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

The language used in the disclosure has been principally selected for readability and instructional purposes, and it may not have been selected to delineate or circumscribe the disclosed subject matter. Accordingly, the disclosure is illustrated and described with reference to various example embodiments and is intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method performed by a secondary Network Function (NF) node of establishing security context in a distributed Non-Access Stratum (NAS), the method comprising:
receiving, from a User Equipment (UE) or a primary NF node, an encoded service message associated with a Non-Access Stratum (NAS) procedure for establishing an NF specific security context for the secondary NF node;
determining whether a security context is already established between the UE and the secondary NF node, based on at least one of information included in the encoded service message or a query to a Security Function (SF) node storing a primary security context;
based on the determination, causing establishment of the security context by performing one of:
retrieving, from the SF node, at least one of the primary security context or a shared security context, previously established between the UE and the primary NF node, wherein the UE previously initiated a primary authentication and key agreement procedure with the primary NF node, or
initiating, with the UE, at least one of a secondary authentication and key agreement procedure, or a Security Mode Command (SMC) procedure to derive the NF specific security context.

2. The method of claim 1, wherein the determining whether the security context is already established comprises:
identifying a common security context between the UE and the secondary NF node based on the information included in the encoded service message comprising a Key Set Identifier (KSI), a security header type and a message type.

3. The method of claim 1, wherein the NF specific security context comprises at least one of newly derived integrity and cipher keys, a new KSI identifying the NF specific security context, and integrity and ciphering algorithm identifiers, and
wherein the encoded service message corresponds to at least one of a plain NAS message, a message derived from the primary security context, a message derived from a Key Derivation Function (KDF) identifier, and a message derived from the NF specific security context.

4. The method of claim 1, wherein the retrieving the at least one of the primary security context or the shared security context further comprises:
deriving the NF specific security context using a KDF identifier, based on the encoded service message corresponding to a message derived from the KDF identifier.

5. The method of claim 1, wherein the causing the establishment of the security context comprises verifying the encoded service message, based on the encoded service message being received from the primary NF node, and the encoded service message corresponding to a message derived from the NF specific security context, wherein the message comprises a portion encrypted with the NF specific security context associated with the secondary NF node,
wherein the causing the establishment of the security context further comprises:
detecting a change in a serving instance of the secondary NF node due to UE mobility or network reconfiguration;
based on the detection, performing one of:
retrieving the NF specific security context from the SF node or from a previous instance of the secondary NF node, and
re-deriving the NF specific security context using stored security context parameters; and
transmitting, to the UE, an indication message specifying whether the shared security context or the NF specific security context is to be used for communication with the secondary NF node, and
wherein the stored security context parameters comprises at least one of a network function identifier, a serving network name, an uplink NAS count value, and a downlink NAS count value.

6. The method of claim 1 further comprising:
decoding the encoded service message using at least one of the primary security context, the shared security context, or the NF specific security context.

7. A secondary Network Function (NF) node for establishing security context in a distributed Non-Access Stratum (NAS), comprising:
at least one processor comprising processing circuitry; and
a memory communicatively coupled to at least one processor, wherein the memory stores instructions, which, on execution, by at least one processor, individually or in any combination, causes the secondary NF node to:
receive, from a User Equipment (UE) or a primary NF node, an encoded service message associated with a Non-Access Stratum (NAS) procedure for establishing an NF specific security context for the secondary NF node;
determine whether a security context is already established between the UE and the secondary NF node, based on at least one of information included in the encoded service message or a query to a Security Function (SF) node storing a primary security context;
based on the determination, cause establishment of the security context by performing one of:
retrieving, from the SF node, at least one of the primary security context or a shared security context, previously established between the UE and the primary NF node, wherein the UE previously initiated a primary authentication and key agreement procedure with the primary NF node, or
initiating, with the UE, at least one of a secondary authentication and key agreement procedure, or a Security Mode Command (SMC) procedure to derive the NF specific security context.

8. The secondary NF node of claim 7, wherein at least one processor, individually or in any combination, is configured to cause the secondary NF node to:
identify a common security context between the UE and the secondary NF node based on the information included in the encoded service message comprising a Key Set Identifier (KSI), a security header type and a message type.

9. The secondary NF node of claim 7, wherein the NF specific security context comprises at least one of newly derived integrity and cipher keys, a new KSI identifying the NF specific security context, and integrity and ciphering algorithm identifiers, and
wherein the encoded service message corresponds to at least one of a plain NAS message, a message derived from the primary security context, a message derived from a Key Derivation Function (KDF) identifier, and a message derived from the NF specific security context.

10. The secondary NF node of claim 7, wherein at least one processor, individually or in any combination, is configured to cause the secondary NF node to:
derive the NF specific security context using a KDF identifier, based on the encoded service message corresponding to a message derived from the KDF identifier.

11. The secondary NF node of claim 10, wherein at least one processor, individually or in any combination, is configured to cause the secondary NF node to verify the encoded service message, based on the encoded service message being received from the primary NF node, and the encoded service message corresponding to a message derived from the NF specific security context, wherein the message comprises a portion encrypted with the NF specific security context associated with the secondary NF node,
wherein at least one processor, individually or in any combination, is configured to cause the secondary NF node to:
detect a change in a serving instance of the secondary NF node due to UE mobility or network reconfiguration;
based on the detection, perform one of:
retrieving the NF specific security context from the SF node or from a previous instance of the secondary NF node, and
re-deriving the NF specific security context using stored security context parameters; and
transmit, to the UE, an indication message specifying whether the shared security context or the NF specific security context is to be used for communication with the secondary NF node, and
wherein the stored security context parameters comprises at least one of a network function identifier, a serving network name, an uplink NAS count value, and a downlink NAS count value.

12. The secondary NF node of claim 7, wherein at least one processor, individually or in any combination, is configured to cause the secondary NF node to:
decode the encoded service message using at least one of the primary security context, the shared security context, or the NF specific security context.

13. A method performed by User Equipment (UE) of establishing security context in a distributed Non-Access Stratum (NAS), the method comprising:
maintaining a plurality of security contexts associated with a plurality of Network Functions (NFs) comprising a primary NF node and a plurality of secondary NF nodes;
establishing a primary security context with a primary Network Function (NF) node by initiating a primary authentication and key agreement procedure with the primary NF node; and
transmitting, to the secondary NF node or the primary NF node, an encoded service message associated with a Non-Access Stratum (NAS) procedure for establishing at least one of a shared security context, or an NF specific security context for a secondary NF node.

14. The method of claim 13, wherein the NF specific security context comprises at least one of newly derived integrity and cipher keys, a new KSI identifying the NF specific security context, and integrity and ciphering algorithm identifiers, and
wherein the encoded service message corresponds to at least one of a plain NAS message, a message derived from the primary security context, a message derived from a Key Derivation Function (KDF) identifier, and a message derived from the NF specific security context.

15. The method of claim 13, wherein the encoded service message comprises a first portion encrypted with a first security context associated with the primary NF node, and a second portion encrypted with a second security context associated with the secondary NF node, based on the encoded service message being transmitted to the primary NF node, and the encoded service message corresponding to a message derived from the NF specific security context.

16. The method of claim 13, further comprising:
receiving an indication message specifying whether the shared security context or the NF specific security context is to be used for communication with the secondary NF node, based on a change in a serving instance of the secondary NF node due to UE mobility or network reconfiguration.

17. A User Equipment (UE) for establishing security context in a distributed Non-Access Stratum (NAS), comprising:
at least one processor comprising processing circuitry; and
a memory communicatively coupled to at least one processor, wherein the memory stores instructions, which, on execution by at least one processor, individually or in any combination, causes the UE to:
maintain a plurality of security contexts associated with a plurality of Network Functions (NFs) comprising a primary NF node and a plurality of secondary NF nodes;
establish a primary security context with a primary Network Function (NF) node by initiating a primary authentication and key agreement procedure with the primary NF node; and
transmit, to the secondary NF node or the primary NF node, an encoded service message associated with a Non-Access Stratum (NAS) procedure for establishing one of, a shared security context, or a NF specific security context for a secondary NF node.

18. The UE of claim 17, wherein the NF specific security context comprises at least one of newly derived integrity and cipher keys, a new KSI identifying the NF specific security context, and integrity and ciphering algorithm identifiers, and
wherein the encoded service message corresponds to at least one of a plain NAS message, a message derived from the primary security context, a message derived from a Key Derivation Function (KDF) identifier, and a message derived from the NF specific security context.

19. The UE of claim 17, wherein the encoded service message comprises a first portion encrypted with a first security context associated with the primary NF node, and a second portion encrypted with a second security context associated with the secondary NF node, based on the encoded service message being transmitted to the primary NF node, and the encoded service message corresponding to a message derived from the NF specific security context.

20. The UE of claim 17, wherein at least one processor, individually or in any combination, is configured to cause the UE to:
receive an indication message specifying whether the shared security context or the NF specific security context is to be used for communication with the secondary NF node, based on a change in a serving instance of the secondary NF node due to UE mobility or network reconfiguration.
